(19) United States
(12) Patent Application Publication
(10) Pub. No.: US 2014/0040468 A1
(43) Pub. Date: Feb. 6, 2014

(54) PORT NUMBER IDENTIFICATION SYSTEM, PORT NUMBER IDENTIFICATION SYSTEM CONTROL METHOD, AND CONTROL PROGRAM THEREOF

(71) Applicant: Yusuke Uchimura, Tokyo (JP)

(72) Inventor: Yusuke Uchimura, Tokyo (JP)

(73) Assignee: NEC CORPORATION, Minato-ku, Tokyo (JP)

(21) Appl. No.: 14/112,966

(22) PCT Filed: Apr. 17, 2012
(86) PCT No.: PCT/JP2012/060277

§ 371 Date: Oct. 21, 2013

(30) Foreign Application Priority Data
Apr. 22, 2011 (JP) 2011-095780

(51) Int. Cl. H04L 12/26

(52) U.S. Cl. CPC H04L 43/04
USPC 709/224

(57) ABSTRACT

A port number file verification function assesses whether a port number file is present in an administrated machine side storage module. If not present in the administrated machine side storage module, or if present in the administrated machine side storage module and communication with a port number of an administration server which is recorded in the present port number file is not possible, a port number file acquisition directive function directs a file acquisition unit to acquire a port number file of the administration server, the file acquisition unit which receives the directive requests the port number file via the administration server and a well-known port, and a port number identification function identifies a port number of the administration server on the basis of the content of the port number file which is acquired by the request.

### TECHNICAL FIELD

The present invention relates to a port number identification system and, more specifically, to a port number identification system which acquires and identifies the port number of a communication port used when an administrated server communicates with an administration server via a well-known port.

### BACKGROUND ART

Regarding servers for operating business services or business terminals (PC: Personal Computers), the number of steps required for construction thereof is increased as the number thereof to be installed is increased. Thus, deployment of a system (OS: Operating System) is employed.

The deployment system mentioned above is a system which acquires a disk image of an already set-up OS, and executes automatic set-up of the OS by collectively distributing it to a plurality of servers or business terminals.

In general, such system is constituted with an administration server which distributes the disk image, and an administrated machine which executes set-up of an OS by using the disk image distributed from the administration server.

Recently, due to the spread of virtualization, a virtual OS has come to be in a structure that does not depend on the physical environments. Therefore, there are more and more cases where the virtual OS is utilized for other systems. With the deployment system, the disk image is also being utilized to other systems recently.

As specifically known content of the technical field described above for that, there are Patent Documents 1 to 3.

The technique disclosed in Patent Document 1 describes about a connection-oriented network automatic setting system with which changes in the setting of the system are automatically reflected, and described about a method for setting network information automatically by communication done between an automatic setting server and a client.

Further, the technique disclosed in Patent Document 2 is a technique with which a resource administration server can allot hardware resources for administrated machines when the administrated machines use the hardware resources under an environment where the hardware resources (magnetic tape, hard disk driver, and the like), the administrated machines that use the hardware resources, and the resource administration server that allots the hardware resources to the administrated machines are connected to a same network.

Further, the technique disclosed in Patent Document 3 is a technique which distributes the load of a gateway to a partner processor to reduce the load of the gateway and, further, makes it possible to handle parallel and distributed systems connected to an inside network as a single system.
Patent Document 1: Japanese Unexamined Patent Publication Hei 10-98480
Patent Document 2: Japanese Unexamined Patent Publication Hei 5-100984
Patent Document 3: Japanese Unexamined Patent Publication Hei 9-204376

However, the deployment system normally stores agent programs within an already set-up OS and creates a disk image for each of the agent programs, so that the port numbers used in the communication between the administration server and the administrated machines are acquired in fixed values. Thus, when the disk image is transferred to another system that has a different port number, the administrated machine has no way to know the port number of the administration server and fails to establish the communication. This issue occurs since the conventional methods hold the information of the port numbers with fixed numbers in a registry.

The technique disclosed in Patent Document 1 cannot be utilized in another system having different port number. Therefore, there is required a method which automatically changes the setting of the port number without requiring the user to manually reset the port number even in a case where the port number is changed as in the case where the disk image is transferred to another system having different port number.

Further, the techniques disclosed in Patent Document 2 and Patent Document 3 are not capable of acquiring the port number dynamically when transferred to another system having a different port number.

The object of the present invention is to improve the inconveniences of the above-described related techniques and to provide a port number identification system which can easily identify the port number of the administration server side from the administrated machine in a case where the port number of the communication port of the administration server side is changed and the connection-destination port number cannot be identified.

### DISCLOSURE OF THE INVENTION

In order to achieve the foregoing object, the port number identification system according to the present invention is characterized as a port number identification system which includes: an administration server which includes a plurality of multi-purpose ports with different port numbers and individually accepts connection from outside via each of the multi-purpose ports; and a plurality of administrated machines which perform communication by designating one of the multi-purpose ports as a connection destination, wherein the administration server and each of the administrated machines include, separately from the plurality of multi-purpose ports, a plurality of exclusive ports whose use purposes are designated by each port number, and the administration server includes: an administration server side storage module to which a port number file containing port number information set anew by the administration server is stored; and a file server unit which takes out the port number file from the administration server side storage module in response to a request for the port number file made from the administrated machine via the exclusive port, and transmits the port number file to the administrated machine via the exclusive port.

Further, the port number identification system control method is characterized as a port number identification system control method used in a port number identification system including an administration server which includes a plurality of multi-purpose ports with different port numbers and individually accepts connection from outside via each of the multi-purpose ports, and a plurality of administrated machines which perform communication by designating one of the multi-purpose ports as a connection destination, wherein: a manager side deployment function distributes setting information of an operating system to the administrated machine; an agent side deployment function builds an operating system based on the setting information of the operating system; a port number file verification function verifies whether or not a port number file is stored in an administrated machine side storage module; when the port number file is stored, a connection judgment function judges whether or not it is possible to connect to a multi-purpose port of a port number set in advance as a connection destination; when connection to the port number cannot be established, a port number file acquisition directive function transmits an acquisition directive for the port number file to a file acquisition module; the file acquisition module upon receiving the file acquisition directive requests the port number file to the administration server via an exclusive port; a port number file request accepting function accepts the request for the port number file via the exclusive port; a port number file reading function reads the port number file from the administration server side storage module based on the request accepted by the port number file accepting function; a port number file transmission function transmits the read port number file to a transmitter of the request for the port number file via the exclusive port; the port number setting module stores the port number file transmitted by the port number file transmission function to an administrated machine side port number file storage module; and a port number identification function identifies the port number of the connection destination based on the port number file stored in the administrated machine side port number file storage module.

Furthermore, the port number identification system control program according to the present invention is a port number identification system control program used in a port number identification system including an administration server which includes a plurality of multi-purpose ports with different port numbers and individually accepts connection from outside via each of the multi-purpose ports, and a plurality of administrated machines which perform communication by designating one of the multi-purpose ports as a connection destination, and the program is characterized to cause a computer provided in advance to the administration server to execute: a manager side deployment function which distributes setting information of an operating system to the administrated machine; a port number file request accepting function which accepts the request for the port number file transmitted from the administration server via the exclusive port; a port number file reading function which reads the port number file from an administration server side storage module based on the request for the port number file; and a port number file transmission function which transmits the read port number file to a transmitter of the request for the port number file via the exclusive port.

The present invention is structured in the manner described above. According to that, it is so structured that the administration server takes out the port number file from the administration server side storage module and transmits it to the administrated machine via the exclusive port in response to a request for the port number file made from the port number identification module of the administrated machine side via the exclusive port. Therefore, it is possible to provide the excellent port number identification system, port number identification system control method, and port number identification system control program, with which the port number identification module of the administrated machine side can automatically identify the port number of the administration server based on the port number file transmitted via the exclusive port.

### BRIEF DESCRIPTION OF THE DRAWINGS

FIG. 1 is a block diagram showing an embodiment of a port number identification system according to the present invention;

FIG. 2 is an illustration showing a logical structure of an administration server 10 disclosed in FIG. 1;

FIG. 3 is an illustration showing a logical structure of an administrated machine 30 disclosed in FIG. 1;

FIG. 4 is an illustration showing a logical structure of a port number file 11a disclosed in FIG. 2;

FIG. 5 is a block diagram showing details of the content of a system A of the administration server 10 of the port number identification system disclosed in FIG. 1;

FIG. 6 is a block diagram showing details of the content of a system B of the administration server 10 of the port number identification system disclosed in FIG. 5;

FIG. 7 is a block diagram showing details of the content of the administration server 10 in a case where the port number of the port number identification system disclosed in FIG. 1 is dynamically changed;

FIG. 8 is a block diagram showing details of the content of the administrated machine 30 of the system A of the port number identification system disclosed in FIG. 1;

FIG. 9 is a block diagram showing details of the content of the system B of the administrated machine 30 disclosed in FIG. 8;

FIG. 10 is a flowchart showing actions of the administrated machine 30 disclosed in FIG. 1;

FIG. 11 is shows actions of a case where the port number of the administrated machine 30 disclosed in FIG. 1 is dynamically changed;

FIGS. 12A and 12B show charts of example of set values of the port number identification system, in which 12A shows examples of the set values of the system A and 12B shows the set values of the system B;

FIGS. 13A and 13B show charts illustrating the state where the set values of FIG. 9B are rewritten by a port number setting module 31b, in which 13A shows the state where the set values of the system A are set and 13B shows the state where the port number setting module 31b rewrites the port numbers;

FIGS. 14A and 14B show charts of examples of set values of the port number identification system, in which 14A shows examples of the initial values and 14B shows a case where the port number of the administration server 10 is changed; and

FIG. 15 is a chart showing the state where the set values of FIG. 14B are rewritten by the port number setting module 31b.

### BEST MODES FOR CARRYING OUT THE INVENTION

### Embodiment

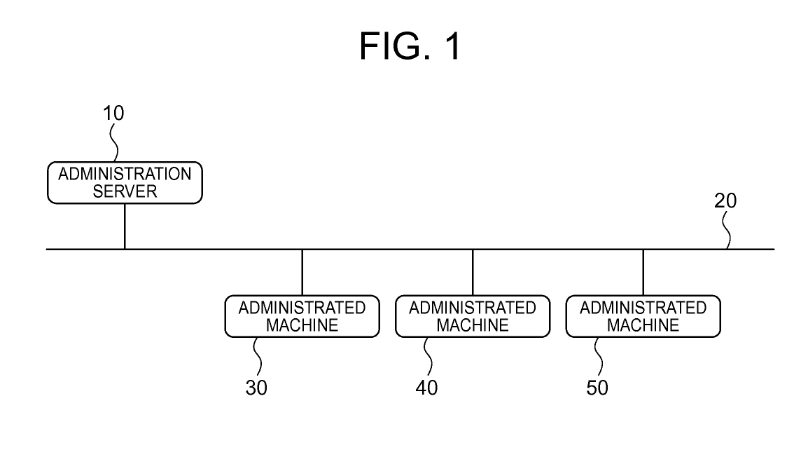

Hereinafter, an embodiment of the port number identification system according to the present invention will be described by referring to FIG. 1 to FIG. 5.

First, as shown in FIG. 1, the port number identification system of the embodiment includes: an administration server 10 which administers and controls an administrated machine 30 via an administration network 20; the administration network 20 as a network infrastructure that is connected to the administration server 10 and the administrated machine 30; and the administrated machines 30 to 50 which are administered and controlled by the administration server 10 via the administration network 20.

FIG. 1 shows an example for schematically describing the embodiment, which is not intended to limit the system structure thereto. That is, the administrated machines 30 to 50 can be set in an arbitrary number according to the system by which those are administered and controlled. In the embodiment, out of the administrated machines 30 to 50, processing actions between the administrated machine 30 and the administration server 10 will be described.

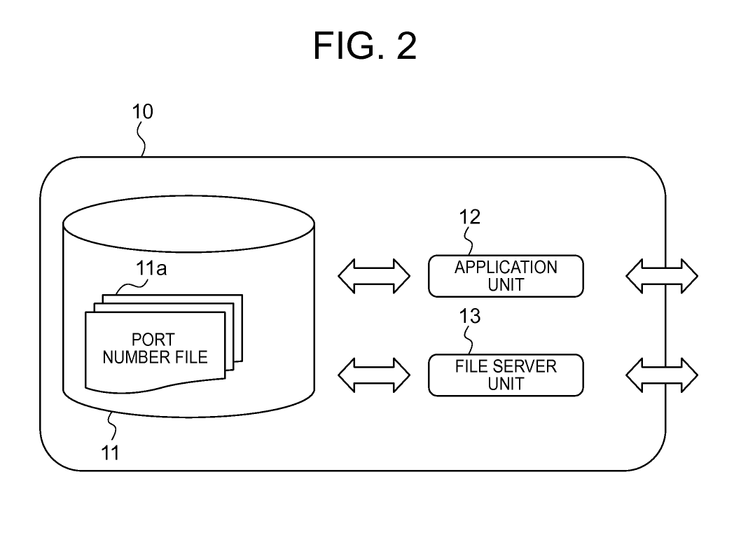

The logical structure of the above-described administration server 10 can be schematically illustrated as in FIG. 2. As shown in FIG. 2, the administration server 10 includes: an application unit 12 which is connected to the administrated machine 30 and deploys the system; an administration server side storage module 11 which stores a port number file 11a in which the port number of the administration server 10 is recorded; and a file server unit 13 which transmits the port number file 11a to the outside via the administration network 20.

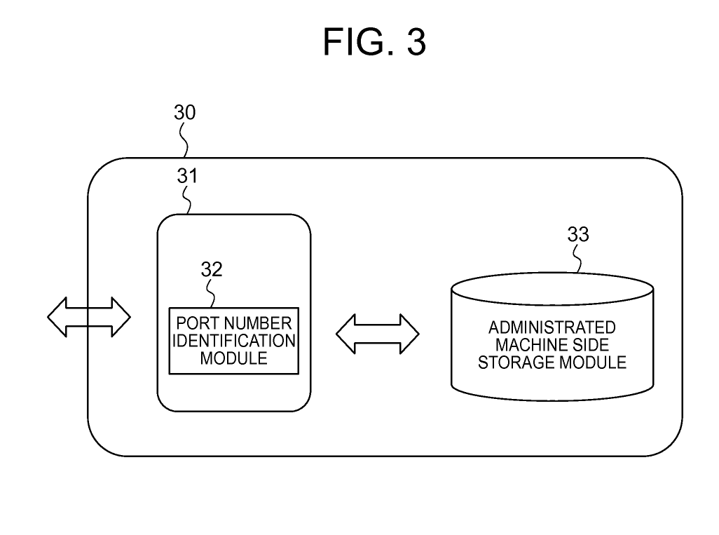

In the meantime, the logical structure of the above-described administrated machine 30 can be schematically illustrated as in FIG. 3. As shown in FIG. 3, the administrated machine 30 includes: an application unit 31 connected to the administration server 10, to which the system is deployed; and an administrated machine side storage module 33 which stores a file having the same content as that of the above-described port number file 11a.

Note here that “deploy” mentioned above means to set the system to be usable via the network. The administration server 10 connects to the administrated machine 30 via the network 20, and deploys the system to the administrated machine 30 to make the administrated machine 30 useable.

The above-described application unit 31 includes a port number identification module 32 which acquires the port number file 11a from the administration server 10, stores it to the administrated machine side storage module 33, and identifies the port number of the administration server 10 based on the content of the port number file 11a.

Thereby, the application unit 31 can set the port number of the administration server 10 identified by the port number identification module 32 as the connection destination, and communicate with the administration server 10.

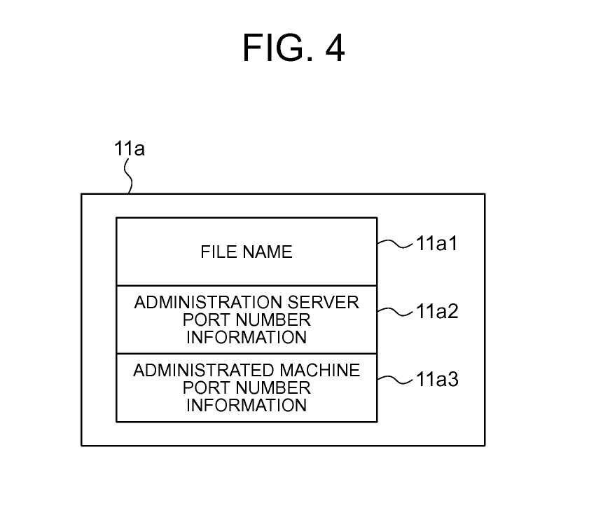

As shown in FIG. 4, the above-described port number file 11a contains, as the port number file information: a file name 11 al that is the name given to the port number file 11a; an administration server port number information 11a2 that is the information of the port number used when the application unit 12 of the administration server 10 communicates with the administrated machine 30; and an administrated machine port number information 11a3 that is the information of the port number used when the administrated machine 30 communicates with the administration server 10.

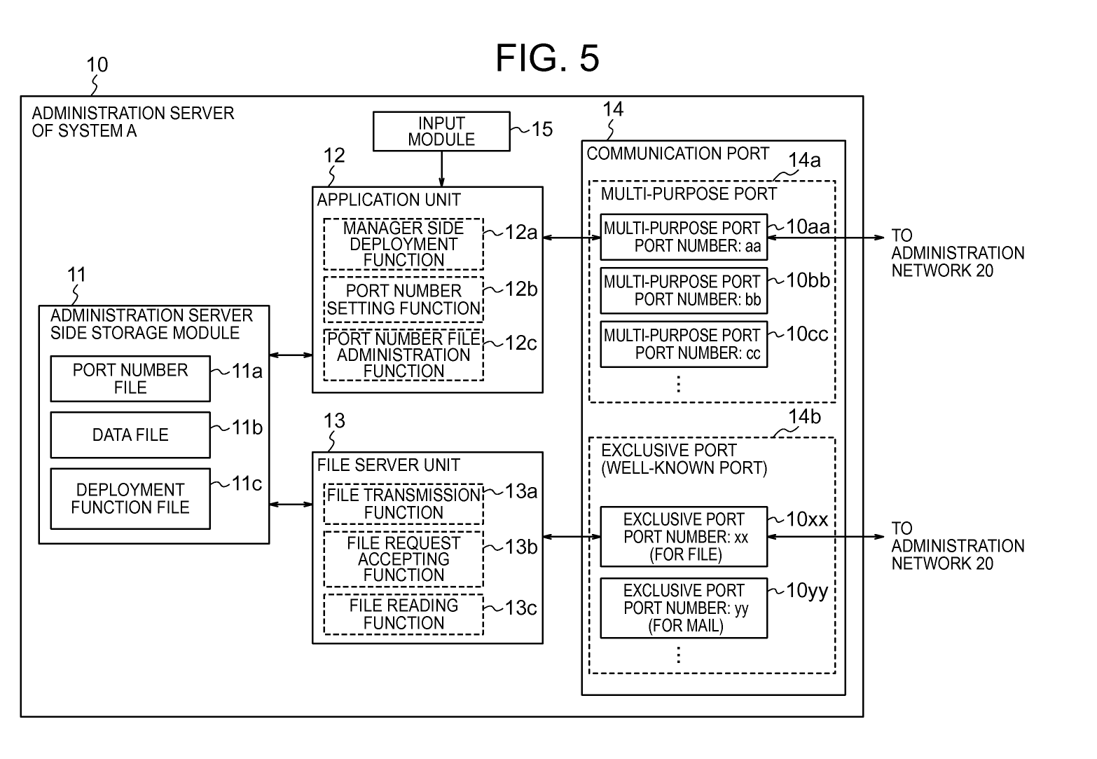

The above-described content of the administration server 10 will be described in more details by referring to FIG. 5.

The administration server 10 includes a communication port 14 that is a connection port provided between itself and the administration network 20. The communication port 14 has a multi-purpose port 14a and an exclusive port (well-known port) 14b.

The above-described multi-purpose port 14a is constituted with a plurality of communication ports (multi-purpose ports) having different port numbers with no limit set in the use purpose. The application unit 12 has a function which performs communication by using the port of the port number designated in advance among the plurality of communication ports.

Further, the above-described well-known port 14b is constituted with communication ports having different port numbers with use purpose being designated in advance for each port number. Regarding the well-known port 14b, the exclusive port 10xx whose port number is xx as shown in FIG. 5 is an exclusive port used for transmitting and receiving the file.

Note here that the above-described application unit 12 includes a manager side deployment function 12a which achieves a deployment function by communicating with an agent side deployment function 31a of the administrated machine 30 to be described later.

The above-described application unit 12 includes: a manager side deployment function 12a which communicates with the application unit 31 of the administrated machine 30 via the communication port 14a and performs deployment; a port number setting function 12b which sets the port number to be used based on the port number file 11a; and a port number file administration function 12c which generates, changes, and deletes the port number file 11a based on the information inputted from outside via an input module 15 provided in advance to the administration server 10.

Thereby, when the user operates the application unit 12 via the input module 15, the port number file administration function 12c can change the content of the port number file 11a and reflect the change content to the application unit 12.

The above-described file server 13 includes: a port number file request accepting function 13a which accepts a request of the port number file 11a via the well-known port 14b; a port number file reading function 13c which reads the port number file 11a based on the request accepted by the port number file request accepting function 13b; and a port number file transmission function 13a which transmits the content read by the port number file reading function 13c to the administrated machine 30 via the well-known port 14b.

Thereby, the port number file request accepting function 13b accepts the request for the port number file from outside, and the port number file reading function 13c upon receiving the request can read the port number file 11a.

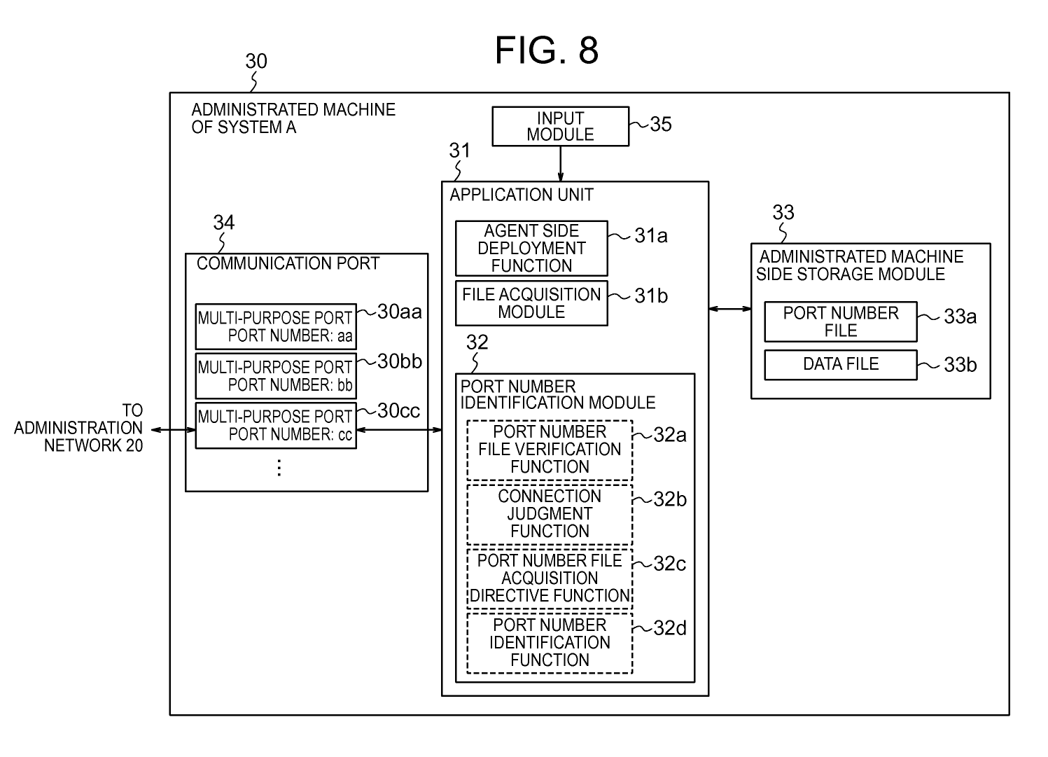

The content of the administrated machine 30 described above will be described in more details by referring to FIG. 8.

The administrated machine 30 includes a communication port as a connection port 34 between itself and the administration network 20. The communication port 34 constituted with a plurality of communication ports (multi-purpose ports) having different port numbers. The application unit 31 has a function which performs communication by using the port of the port number designated in advance among the plurality of communication ports.

The above-described application unit 31 includes the agent side deployment function 31a which achieves a deployment function by communicating with the manager side deployment function 12a of the administration server 10.

The application unit 31 includes the port number identification module 32, and the port number identification module 32 includes a port number file verification function 32a which verifies whether or not a port number file 33a is stored in the administrated machine side port number file storage module 33.

Further, the application unit 31 includes a file acquisition module 31b, and the file acquisition module 31b has a function which communicates with the file server unit 13 via the well-known port 14b of the administration server 10 via the exclusive port 10xx, requests a file designated from the administration server side storage module 11, and stores the acquired file to the administrated machine side storage module 33.

Thereby, even when the port number of the administration server 10 is unknown, the file acquisition module 31b can connect to the administration server 10 via the exclusive port 10xx that is the well-known port used for transmitting and receiving the file, acquire the file stored in the administration server side storage module 11, and store it to the administrated machine side storage module 33.

The above-described port number identification module 32 includes a port number file acquisition directive function 32c which directs the file acquisition module 31b to acquire the port number file 11a in a case where the port number file 33a is not stored and in a case where the communication fails.

Thereby, the port number file acquisition directive function 32c can direct to the file acquisition module 31b to acquire the port number file 11a, and the file acquisition module 31b can acquire the port number file 11a from the administration server 10 and store it to the administrated machine side storage module 33.

Further, the port number identification module 32 includes a port number identification function 32d which identifies the port number of the administration server 10 that is the connection destination of the application unit 31 based on the port number of the administration server 10 recorded on the port number file 33a that is stored in the administrated machine side storage module 33.

Thereby, the port number file verification function 32a can verify whether or not there is the port number file 33a in the administrated machine side storage module 33; the connection judgment function 32b can judge whether or not it is possible to connect to the port number recorded on the port number file 33a when there is the port number file 33a; the port number file acquisition directive function 32c can direct the file acquisition module 31b to acquire the port number file 11a when judged that it is not possible to connect and when there is a communication error; the file acquisition module 31b upon receiving the directive can request the port number file 11a to the administration server 10 via the well-known port, generate the file of the same content as that of the port number file 11a transmitted from the administration server 10 according to the request as the port number file 33a, and store the port number file 33a to the administrated machine side storage module 33; the port number identification function 32d can identify the port number of the administration server based on the port number file 33a stored in the administrated machine side storage module 33; and the application unit 31 can set the identified port number as the connection destination port number of the administration server 10.

Thereby, the agent side deployment function 31a can deploy the system by communicating with the manager side deployment function 12a via the communication port identified by the port number identification function 32d.

Further, when the port number identification module 32 directs the file acquisition module 31b to acquire the port number file 11a from the administration server 10 and identifies the port number to be used for having communication with the administration server 10 based on the content of the port number file 11a acquired according to the directive, the port number can be identified easily even when the port number of the administration server 10 is changed.

### Actions of Embodiment

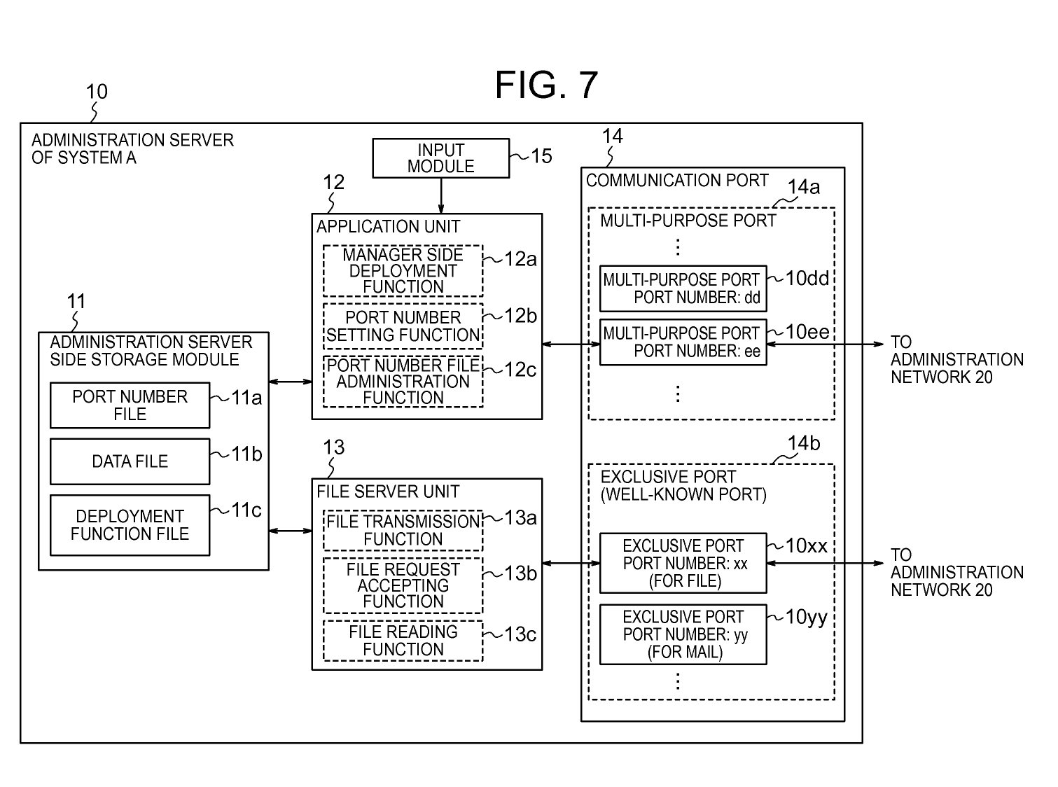

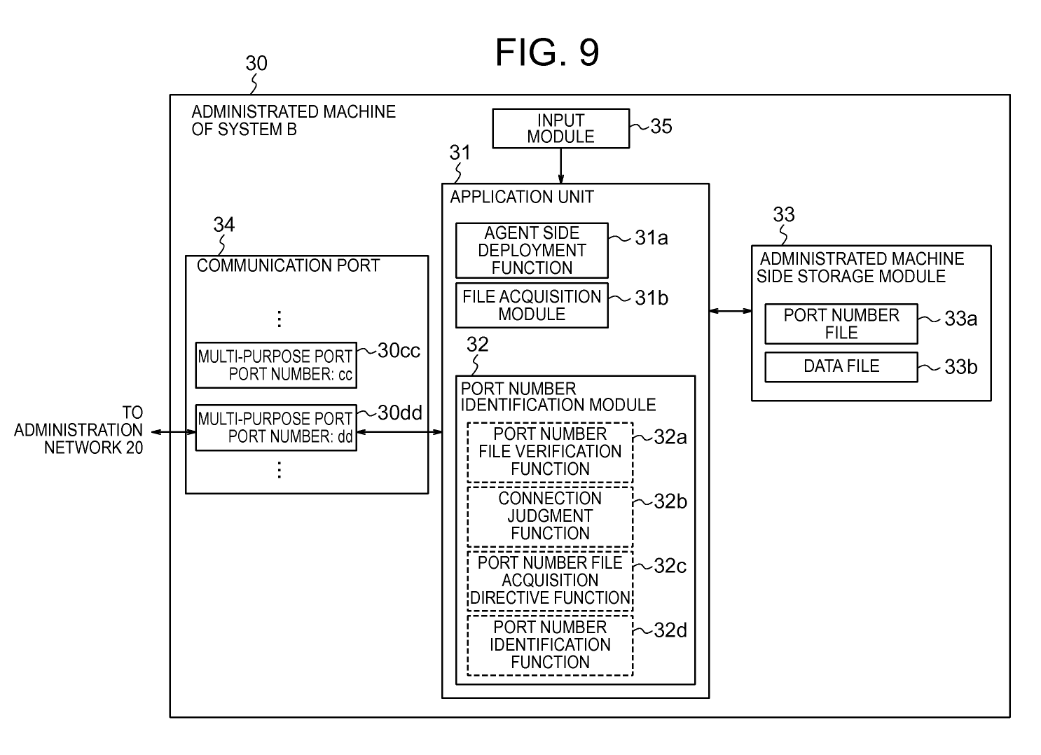

Next, overall actions of the port number identification system will be described by referring to FIG. 5 to FIG. 15.

First, described are the actions executed when the port number file 33a does not exist in the administrated machine side storage module 33, e.g., immediately after the application unit 31 is installed to the administrated machine 30.

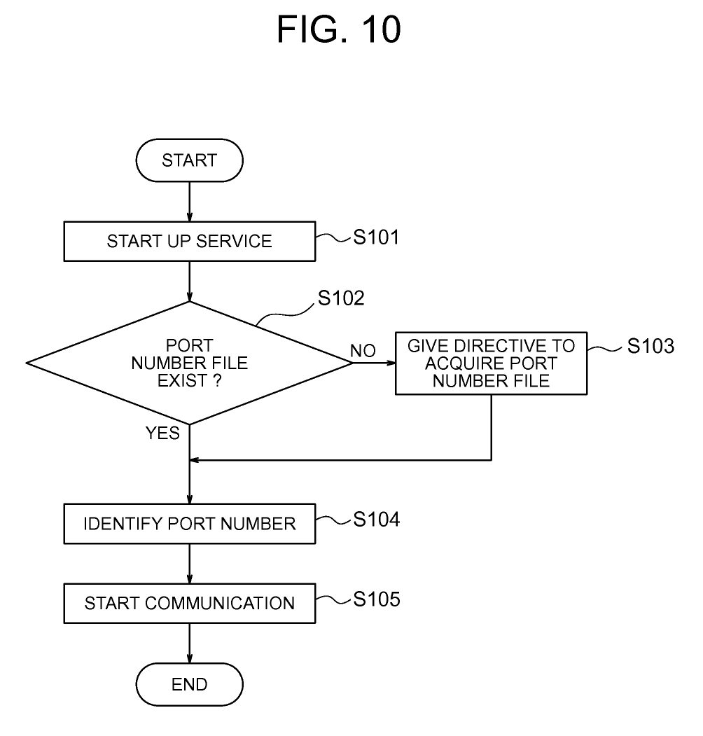

When it is directed to start the application unit 31 of the administrated machine 30 by starting up the OS or the like (FIG. 10: step S101/a service starting step), the port number file verification function 32a of the port number identification module 32 verifies whether or not the port number file 33a is stored in the administrated machine side storage module 33 (FIG. 10: step S102/a set file verification step).

When the port number file verification function 32a verifies that the port number file 33a is not stored in the administrated machine side storage module 33 (FIG. 10: Yes in step S102), the port number file acquisition directive function 32c directs the file acquisition module 31b to acquire the port number file 11a, the file acquisition module 31b upon receiving the command communicates with the file server unit 13 via the well-known port, acquires the content of the port number file 11a stored in the port number file storage module 11, generates a file of the same content as that of the acquired port number file 11a as the port number file 33a, and stores it to the administrated machine side storage module 33 (FIG. 10: step S103/a port number file acquisition step).

Thereafter, the port number file identification function 32d identifies the connection destination port number based on the port number information of the administration server 10 on the port number file 33a stored in the administrated machine side storage module 33 (FIG. 10: step S104/a port number identification step).

Thereby, the communication port designated by the administration server 10 is set as the connection destination of the application unit 31, and the agent side deployment function 31a communicates with the administration server 10 (FIG. 10: step S105/a communication starting step). This makes it possible to achieve the deployment function.

Next, actions of a case where the port number file 33a exists in the administrated machine side storage function 33 will be described.

When it is directed to start the application unit 31 of the administrated machine 30 by starting up the OS or the like (FIG. 10: step S101/the service starting step), the port number file verification function 32a of the port number identification module 32 verifies whether or not the port number file 33a is stored in the administrated machine side module 33 (FIG. 10: step S102/the set file verification step).

When the port number file verification function 32a verifies that the port number file 33a is stored in the administrated machine side storage module 33, the port number identification function 32d sets the connection destination of the application unit 31 based on the port number of the administration server 10 recorded on the port number file 33a (FIG. 10: step S104/the port number setting step), and the agent side deployment function 31a communicates with the administration server 10 via the communication port 14a (FIG. 10: step S105/the communication starting step).

Next, described are actions executed in a case where communication fails because there is no way of knowing the port number of the communication partner, e.g., when the disk image is brought to another system of a different port number.

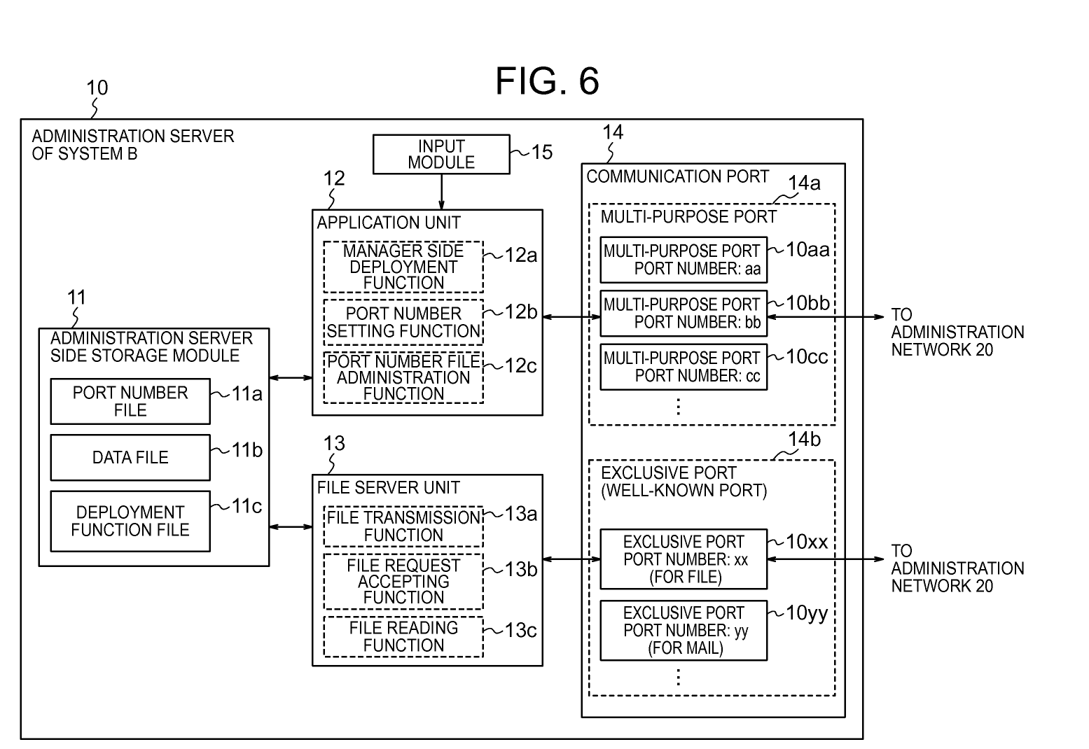

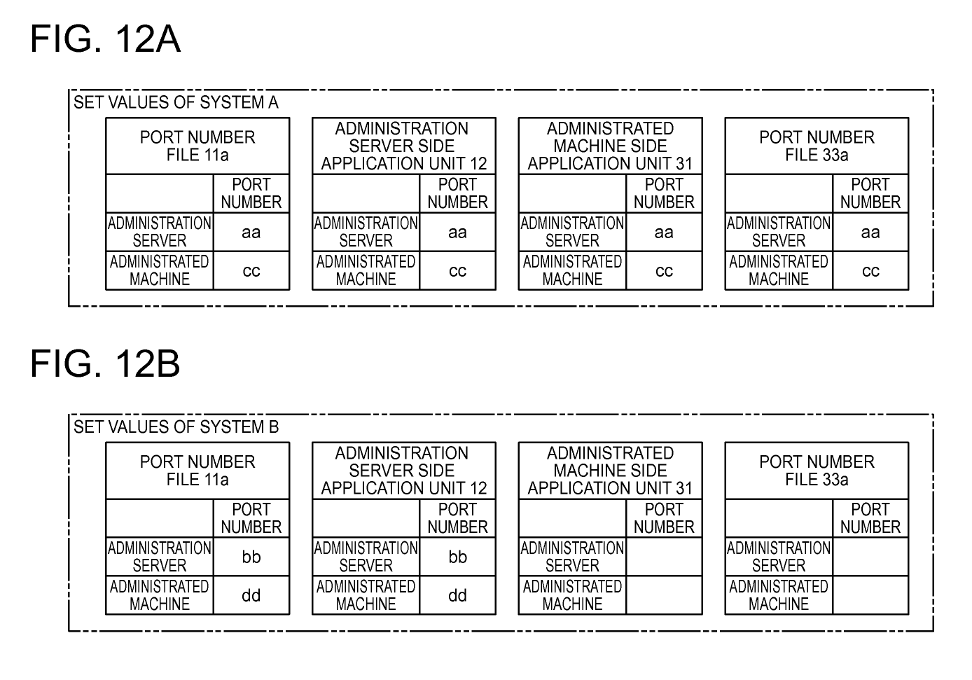

As an example, assumed is a case where the disk image captured in the system A as shown in FIG. 5 and FIG. 8 are brought to the system B as shown in FIG. 6 and FIG. 8 and automatic setup of an OS is executed. As shown in FIG. 12A and FIG. 12B, the port number of an application of the administration server of the system A is defined as aa, the port number of an application of the administration server of the system B is defined bb, the port number of an application of the administrated machine of the system A is defined as cc, and the port number of an application of the administrated machine of the system B is defined as dd.

When the disk image is acquired in the system A, as the port number information, the port number of the application of the administration server is captured as aa and the port number of the application of the administrated machine is captured as cc with the fixed values. At this time, the port number file 33a stored in the administrated machine side storage module 33 of the administrated machine 30 is also captured simultaneously. In the port number file 33a, aa is written as the administration server port number information, and cc is written as the administrated machine port number information.

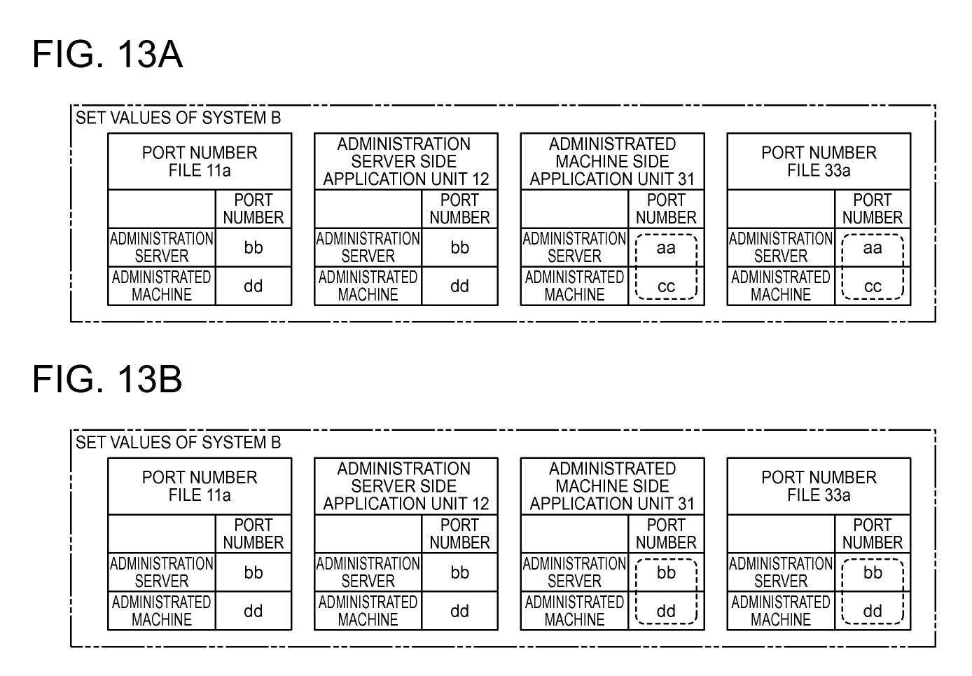

When the disk image captured in the system A is brought to the system B and the automatic setup of the OS is executed, as shown in FIG. 13A, the OS is automatically set up as aa for the port number of the application unit 12 of the administration server 10 side and as cc for the port number of the application unit 31 of the administrated machine 30 side.

Next, when it is directed to start the application unit 31 of the administrated machine 30 by starting up the OS, the port number identification module 32 sets the port number based on the information of the port number file 33a through the procedure described above.

Here, the administration server port number is set as aa and the administrated machine port number information is set as cc in the port number file 33a. Thereafter, the application unit 31 tries to communicate with the application unit 12 of the administration server 10 of the system B for reflecting the individuality. However, the port number of the application of the administration server 10 of the system B is bb which is a different port number, so that the communication fails.

When the communication fails, the port number identification module 32 directs the file acquisition module 31b to acquire the port number file 11a. The file acquisition module 31b upon receiving it communicates with the file server of the administration server 10 of the system B by using the well-known port 14b, acquires the content of the port number file 11a stored in the administration server side storage module 11, generates a file of the content same as the acquired content as the port number file 33a, and stores it to the administrated machine side storage module 33.

Here, in the port number file 33a described above, bb is written as the port number information of the administration server 10 and dd is written as the port number information of the administrated machine 30 as shown in FIG. 13B.

Subsequently, the port number identification module 32 sets the port number of the administration server 10 based on the content of the port number file 33a, and the agent side deployment function 31a achieves the deployment function by communicating with the administration server 10 by having the communication port 14a of the port number set by the file acquisition module 31b as the connection destination.

It is assumed here that some kind of method is used as a method for acquiring the IP address of the administration server 10. As an example of the acquiring method, the user inputs the broadcast and the IP address designating the DHCP, for example.

Next, described are actions executed when communication fails due to changes in the setting of the port number and the like even when the port number file 33a exists in the administrated machine side storage module 33. As an example, assumed is a case where the port number of the administrated server within the system A is changed.

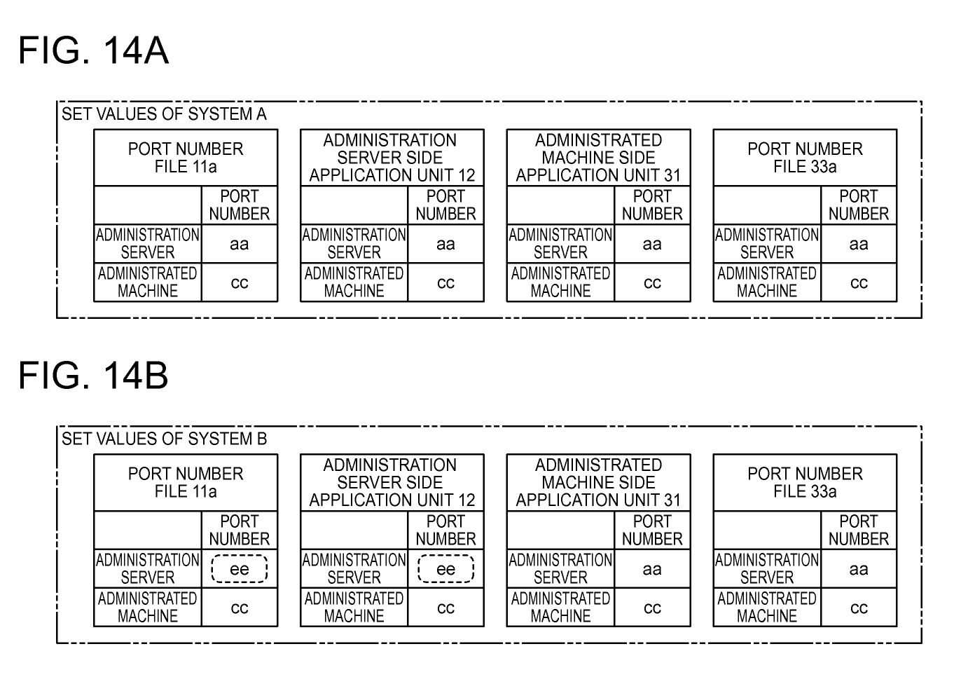

First, as shown in FIG. 14A, as the initial values of the port numbers, aa is set as the port number of the application of the administration server of the system A, and cc is set as the port number of the application of the administrated machine of the system A. Further, it is assumed that the port number file 11a is stored in the administrated machine of the system A.

In the port number file 12, aa is written as the port number of the administration target server 10 and cc is written as the port number of the administrated machine 30 as shown in FIG. 14A.

Described is a case where the port number of the administration server 10 is changed from aa to ee in the system A as shown in FIG. 14B.

The port number file administration function 12c rewrites the port number of the administration server of the port number file 11a from aa to ee based on the information inputted from outside via the input module 15.

When the content of the port number file 11a is updated by the above-described port number file administration function 12c, the application unit 12 sets the port number written in the content of the port number file 11a in the administration server 10 at an arbitrary timing, and changes the port number of the administration server 10 from aa to ee.

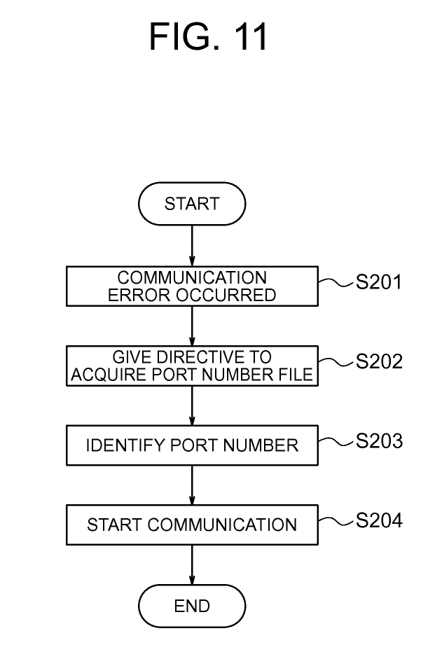

When the application 31 of the administrated machine 30 tries to communicate with the administrated machine 30 under such state, communication fails since the port number of the administration server 10 is different (FIG. 11: S201).

As shown in FIG. 14, the reason for failing the communication is that aa is written as the administration server port number and cc is written as the administrated machine port number information on the port number file 11a, and the port number used for the communication made from the administrated machine 30 to the administration target server 10 is set as aa.

When the communication fails, the port number identification module 32 directs the file acquisition module 31b to acquire the port number file, and the file acquisition module 31b upon receiving the command communicates with the file server unit 13 by using the well-known port 14b and requests the content of the port number file 11a stored in the administration server side storage module 11 (FIG. 11: S202).

When the port number file request accepting function 13b accepts the request for the port number file 11a from the file acquisition module 31b, the port number file reading function 13c reads the content of the port number file 11a stored in the administration server side storage module 11, and the port number file transmission function 13a transmits the content read by the port number file reading function 13c to the transmitter that has transmitted the request for the port number file 11a via the well-known port 14b.

Thereby, the content of the port number file 11a is transmitted to the administrated machine 30 from the administration server 10, so that the administrated machine 30 can grasp the port number of the administration server 10.

When acquiring the content of the port number file 11a from the administration server 10 via the well-known port 14b, the file acquisition module 31b generates the port number file 33a as a file of the same content as that of the port number file 11a, and stores the generated port number file 33a in the administrated machine side storage module 33 (FIG. 11: S203).

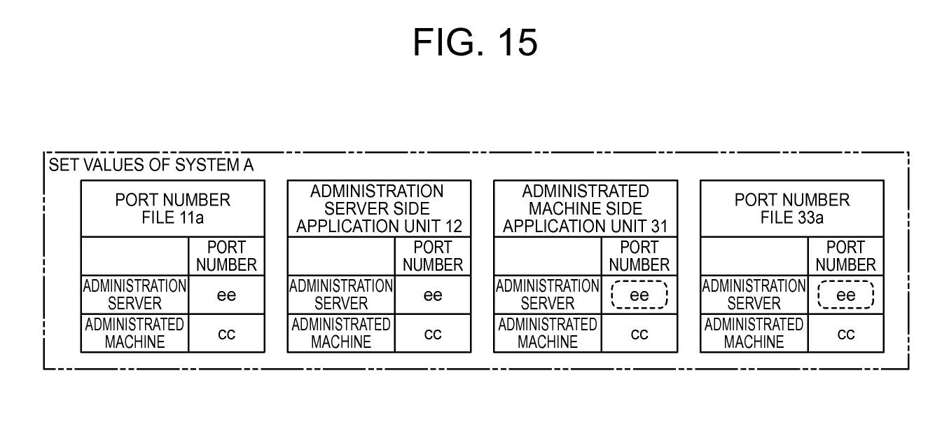

As shown in FIG. 15, ee is written as the administration server port number information and cc is written as the administrated machine port number information on the port number file 33a. The port number is set based on the port number file to communicate with the administration server (FIG. 11: S204).

Thereby, the agent side deployment function 31a can achieve the deployment function by communicating with the manager side deployment function 12a by having the multi-purpose port 14a identified by the port number identification module 32 as the connection destination.

Note here that it is possible to employ a structure with which execution contents of each of the steps such as the manager side deployment step, the port number file request accepting step, the port number file reading step, and the port number file transmitting step regarding the action contents of the embodiment described above are put into a program to have it functionalized by a computer that is provided in advance to the administration server 10.

Further, it is also possible to employ a structure with which execution contents of each of the steps such as the agent side deployment step, the port number file verification step, the port number file request step, the port number file acquisition step, and the port number file setting step regarding the action contents of the embodiment described above are put into a program to have it functionalized by a computer that is provided in advance to the administrated machine 30.

In such case, the program may be recorded on a non-transitory recording medium such as a DVD, a CD, a flash memory, or the like. In that case, the program is read out from the recording medium and executed by the computer.

Further, while the processing actions of the administrated machine 30 among the administrated machines 30 to 50 and the administration server 10 are described above in the embodiment, the administrated machines 40 and 50 also operate in the same manner as that of the administrated machine 30. Therefore, same effects can be acquired with those.

### Effects of Embodiment

As described above, it becomes possible to acquire the content of the port number file 11 and acquire the port number of the administration server 10 even when the port number of the communication port 14a of the administration server 10 is unknown through the following actions: the port number file verification function 32a verifies whether or not the port number file 33a exists in the administrated machine side storage module 33 and judges that the port number file 33a does not exist or judges that the port number file 33a exists but the connection judgment function 32b judges that it is not possible to connect to the port number of the administration server 10 recorded on the port number file 33a, the port number file acquisition directive function 32c directs the file acquisition module 31b to acquire the port number file 11a; the file acquisition module 31b upon receiving the directive requests the port number file IIa to the administration server 10 via the well-known port 14b; the port number file request accepting function 13b accepts the request; the port number file reading function 13c reads the content of the port number file 11a from the administration server side storage module 11; the port number file transmission function 13a transmits the content read out by the port number file reading function 13c to the administered machine 30; the file acquisition module 31b generates a file of the same content as that of the port number file 11a transmitted from the administration server 10 as the port number file 33a and stores it to the administrated machine side storage module 33; the port number identification function 32d identifies the port number of the administration server 10 based on the content of the port umber file 33a; and the application unit 31 sets the identified port number as the connection destination of the administration server 10.

Regarding the embodiment described above, the new technical contents of the above-described embodiment can be summarized as follows.

While a part of or a whole part of the embodiment can be summarized as follows as the new techniques, the present invention is not necessarily limited only to the followings.

### (Supplementary Note 1)

A port number identification system which includes: an administration server which includes a plurality of multi-purpose ports with different port numbers and individually accepts connection from outside via each of the multi-purpose ports; and a plurality of administrated machines which perform communication by designating one of the multi-purpose ports as a connection destination, wherein
the administration server and each of the administrated machines include, separately from the plurality of multi-purpose ports, a plurality of exclusive ports whose use purposes are designated by each port number, and
the administration server includes: an administration server side storage module to which a port number file containing port number information set anew by the administration server is stored; and a file server unit which takes out the port number file from the administration server side storage module in response to a request for the port number file made from the administrated machine via the exclusive port, and transmits the port number file to the administrated machine via the exclusive port.

### (Supplementary Note 2)

The port number identification system as depicted in Supplementary Note 1, wherein:
each of the administrated machines includes: a file acquisition module which requests the port number file to the administration server via the exclusive port and acquires the port number file transmitted via the exclusive port; and a port number identification module which judges whether or not connection via the exclusive port can be done and, when judged that the connection cannot be done, directs the file acquisition module to acquire the port number file; and
the port number identification module is structured to identify the designated port number based on the port number file acquired by the file acquisition module and to use the port number as a connection destination of the administration server.

### (Supplementary Note 3)

The port number identification system as depicted in Supplementary Note 1, wherein:
the administrated machine includes an administrated machine side storage module which stores the port number file acquired via the exclusive port;
the port number identification module includes a port number file verification function which verifies whether or not the port number file is stored in the administrated machine side storage module; and
the port number identification module directs to acquire the port number file, upon verifying that the port number file is not stored in the administrated machine side storage module.

### (Supplementary Note 4)

The port number identification system as depicted in Supplementary Note 1, wherein the exclusive port is a file transmission and reception exclusive port which performs transmission and reception of information by a file unit.

### (Supplementary Note 5)

The port number identification system as depicted in Supplementary Note 1, wherein:
the administration server includes a manager side deployment function which distributes setting information of an operating system to the administrated machine; and
the administrated machine includes an agent side deployment function which sets up an operating system based on the setting information of the operating system.

### (Supplementary Note 6)

A port number identification system control method used in a port number identification system including an administration server which includes a plurality of multi-purpose ports with different port numbers and individually accepts connection from outside via each of the multi-purpose ports, and a plurality of administrated machines which perform communication by designating one of the multi-purpose ports as a connection destination, wherein:
a manager side deployment function distributes setting information of an operating system to the administrated machine;
an agent side deployment function builds an operating system based on the setting information of the operating system;
a port number file verification function verifies whether or not a port number file is stored in an administrated machine side storage module;
when the port number file is stored, a connection judgment function judges whether or not it is possible to connect to a multi-purpose port of a port number set in advance as a connection destination;
when connection to the port number cannot be established, a port number file acquisition directive function transmits an acquisition directive for the port number file to a file acquisition module;
the file acquisition module upon receiving the file acquisition directive requests the port number file to the administration server via an exclusive port;
a port number file request accepting function accepts the request for the port number file via the exclusive port;
a port number file reading function reads the port number file from the administration server side storage module based on the request accepted by the port number file accepting function;
a port number file transmission function transmits the read port number file to a transmitter of the request for the port number file via the exclusive port;
the port number setting module stores the port number file transmitted by the port number file transmission function to an administrated machine side port number file storage module; and
a port number identification function identifies the port number of the connection destination based on the port number file stored in the administrated machine side port number file storage module.

### (Supplementary Note 7)

A port number identification system control program used in a port number identification system including an administration server which includes a plurality of multi-purpose ports with different port numbers and individually accepts connection from outside via each of the multi-purpose ports, and a plurality of administrated machines which perform communication by designating one of the multi-purpose ports as a connection destination, and the program causes a computer provided in advance to the administration server to execute:
a manager side deployment function which distributes setting information of an operating system to the administrated machine;
a port number file request accepting function which accepts the request for the port number file transmitted from the administration server via the exclusive port;
a port number file reading function which reads the port number file from an administration server side storage module based on the request for the port number file; and
a port number file transmission function which transmits the read port number file to a transmitter of the request for the port number file via the exclusive port.

### (Supplementary Note 8)

A port number identification system control program used in a port number identification system including an administration server which includes a plurality of multi-purpose ports with different port numbers and individually accepts connection from outside via each of the multi-purpose ports, and a plurality of administrated machines which perform communication by designating one of the multi-purpose ports as a connection destination, and the program causes a computer provided in advance to the administrated machine to execute:
an agent side deployment function which builds an operating system based on the setting information of the operating system distributed from the administration server;
   a port number file verification function which verifies whether or not a port number file is stored in an administrated machine side storage module;
   a connection judgment function which judges whether or not it is possible to connect to a port number set in advance as a connection destination when the port number file is stored;
   a port number file acquisition directive function which gives a directive to a file acquisition module to acquire the port number file when it is judged by the connection judgment function that connection cannot be established;
   a file acquisition function which requests the port number file to the administration server via an exclusive port based on the directive by the port number file acquisition directive function; and
   a port number identification function which identifies the port number of the connection destination based on the port number file transmitted from the administration server via the exclusive port.

This application claims the Priority right based on Japanese Patent Application No. 2011-095780 filed on Apr. 22, 2011 and the disclosure thereof is hereby incorporated by reference in its entirety.

### INDUSTRIAL APPLICABILITY

The present invention can be applied to a deployment system constituted with an administration server which distributes a disk image of an OS and an administrated machine which executes deployment based on the OS image distributed from the administration server.

### REFERENCE NUMERALS

10 Administration server
11 Administration server side storage module
11a Port number file
12 Application unit
12a Manager side deployment function
13 File server unit
13a File transmission function
13b File request accepting function
13c File reading function
14a Multi-purpose port
14b Exclusive port (Well-known port)
30 Administrated machine
31 Application unit
31a Agent side deployment function
31b File acquisition unit
32 Port number identification module
32a Port number file verification function
32b Connection judgment function
32c Port number file acquisition directive function
32d Port number identification function
33 Administrated machine side storage function
33a Port number file

What is claimed is:

1. A port number identification system, comprising: an administration server which includes a plurality of multi-purpose ports with different port numbers and individually accepts connection from outside via each of the multi-purpose ports; and a plurality of administrated machines which perform communication by designating one of the multi-purpose ports as a connection destination, wherein
the administration server and each of the administrated machines include, separately from the plurality of multi-purpose ports, a plurality of exclusive ports whose use purposes are designated by each port number, and
the administration server comprises: an administration server side storage module to which a port number file containing port number information set anew by the administration server is stored; and a file server unit which takes out the port number file from the administration server side storage module in response to a request for the port number file made from the administrated machine via the exclusive port, and transmits the port number file to the administrated machine via the exclusive port.

2. The port number identification system as claimed in claim 1, wherein:
each of the administrated machines comprises: a file acquisition module which requests the port number file to the administration server via the exclusive port and acquires the port number file transmitted via the exclusive port; and a port number identification module which judges whether or not connection via the exclusive port can be done and, when judged that the connection cannot be done, directs the file acquisition module to acquire the port number file; and
the port number identification module is structured to identify the port number based on the port number file acquired by the file acquisition module and to use the port number as a connection destination of the administration server.

3. The port number identification system as claimed in claim 1, wherein:
the administrated machine comprises an administrated machine side storage module which stores the port number file acquired via the exclusive port;
the port number identification module includes a port number file verification function which verifies whether or not the port number file is stored in the administrated machine side storage module; and
the port number identification module directs to acquire the port number file, upon verifying that the port number file is not stored in the administrated machine side storage module.

4. The port number identification system as claimed in claim 1, wherein the exclusive port is a file transmission and reception exclusive port which performs transmission and reception of information by a file unit.

5. The port number identification system as claimed in claim 1, wherein:
the administration server includes a manager side deployment function which distributes setting information of an operating system to the administrated machine; and
the administrated machine includes an agent side deployment function which sets up an operating system based on the setting information of the operating system.

6. A port number identification system control method used in a port number identification system comprising an administration server which includes a plurality of multi-purpose ports with different port numbers and individually accepts connection from outside via each of the multi-purpose ports, and a plurality of administrated machines which perform communication by designating one of the multi-purpose ports as a connection destination, wherein:
a manager side deployment function distributes setting information of an operating system to the administrated machine;
an agent side deployment function builds an operating system based on the setting information of the operating system;
a port number file verification function verifies whether or not a port number file is stored in an administrated machine side storage module;
when the port number file is stored, a connection judgment function judges whether or not it is possible to connect to a multi-purpose port of a port number set in advance as a connection destination;
when connection to the port number cannot be established, a port number file acquisition directive function transmits an acquisition directive for the port number file to a file acquisition module;
the file acquisition module upon receiving the file acquisition directive requests the port number file to the administration server via an exclusive port;
a port number file request accepting function accepts the request for the port number file via the exclusive port;
a port number file reading function reads the port number file from the administration server side storage module based on the request accepted by the port number file accepting function;
a port number file transmission function transmits the read port number file to a transmitter of the request for the port number file via the exclusive port;
the port number setting module stores the port number file transmitted by the port number file transmission function to an administrated machine side port number file storage module; and
a port number identification function identifies the port number of the connection destination based on the port number file stored in the administrated machine side port number file storage module.

7. A non-transitory computer readable recording medium storing a port number identification system control program used in a port number identification system comprising an administration server which includes a plurality of multi-purpose ports with different port numbers and individually accepts connection from outside via each of the multi-purpose ports, and a plurality of administrated machines which perform communication by designating one of the multi-purpose ports as a connection destination, the program causing a computer provided in advance to the administration server to execute:
a manager side deployment function which distributes setting information of an operating system to the administrated machine;
a port number file request accepting function which accepts the request for the port number file transmitted from the administration server via the exclusive port;
a port number file reading function which reads the port number file from an administration server side storage module based on the request for the port number file; and
a port number file transmission function which transmits the read port number file to a transmitter of the request for the port number file via the exclusive port.

8. A port number identification system control program used in a port number identification system comprising an administration server which includes a plurality of multi-purpose ports with different port numbers and individually accepts connection from outside via each of the multi-purpose ports, and a plurality of administrated machines which perform communication by designating one of the multi-purpose ports as a connection destination, the program causing a computer provided in advance to the administrated machine to execute:
an agent side deployment function which builds an operating system based on the setting information of the operating system distributed from the administration server;
a port number file verification function which verifies whether or not a port number file is stored in an administrated machine side storage module;
a connection judgment function which judges whether or not it is possible to connect to a port number set in advance as a connection destination when the port number file is stored;
a port number file acquisition directive function which gives a directive to a file acquisition module to acquire the port number file when it is judged by the connection judgment function that connection cannot be established;
a file acquisition function which requests the port number file to the administration server via an exclusive port based on the directive by the port number file acquisition directive function; and
a port number identification function which identifies the port number of the connection destination based on the port number file transmitted from the administration server via the exclusive port.

9. A port number identification system, comprising: an administration server which includes a plurality of multi-purpose ports with different port numbers and individually accepts connection from outside via each of the multi-purpose ports; and a plurality of administrated machines which perform communication by designating one of the multi-purpose ports as a connection destination, wherein
the administration server and each of the administrated machines include, separately from the plurality of multi-purpose ports, a plurality of exclusive ports whose use purposes are designated by each port number, and
the administration server comprises: administration server side storage module to which a port number file containing port number information set anew by the administration server is stored; and file server means for taking out the port number file from the administration server side storage module in response to a request for the port number file made from the administrated machine via the exclusive port, and transmitting the port number file to the administrated machine via the exclusive port.
